(19) United States
(12) Patent Application Publication
(10) Pub. No.: US 2013/0216826 A1
(43) Pub. Date: Aug. 22, 2013

(54) THERMOSETTING COMPOSITION FOR PROTECTIVE FILM OF TRANSPARENT CONDUCTIVE FILM

(71) Applicant: JNC CORPORATION, (US)

(72) Inventors: KEIICHI NAKAMOTO, CHIBA (JP); MOTOKI YANAI, CHIBA (JP); SETSUO ITAMI, CHIBA (JP)

(73) Assignee: JNC CORPORATION, TOKYO (JP)

(21) Appl. No.: 13/743,334

(22) Filed: Jan. 17, 2013

(30) Foreign Application Priority Data
Feb. 21, 2012 (JP) 2012-034869

(51) Int. Cl. C09D 5/24

(52) U.S. Cl. CPC C09D 5/24; Y10S 977/762; B82Y 40/00
USPC 428/336; 427/108; 252/500; 252/512; 252/514; 977/762

(57) ABSTRACT

A thermosetting composition for forming a protective film of a transparent conductive film is described, containing: a polyester amide acid obtained from a reaction of a mixture containing a tetracarboxylic dianhydride, a diamine and a polyhydric hydroxy compound as a first component, an epoxy resin as a second component, an epoxy curing agent as a third component, and a solvent as a fourth component.

### CROSS-REFERENCE TO RELATED APPLICATION

This application claims the priority benefit of Japan Application No. 2012-034869, filed on Feb. 21, 2012. The entirety of the above-mentioned patent application is hereby incorporated by reference herein and made a part of this specification.

### TECHNICAL FIELD

The present invention relates to a thermosetting composition for forming a protective film of a transparent conductive film including a nanostructure. More specifically, the invention relates to a method for manufacturing a protective film that has good optical characteristics, can provide a transparent conductive film with a high hardness and a high environmental resistance, and can maintain the electrical contactability with the transparent conductive film, and relates to a device element using the protective film.

### BACKGROUND ART

A transparent conductive film is used in various fields such as a transparent electrode for a liquid crystal display (LCD), a plasma display panel (PDP), an organic electroluminescence display, a photovoltaic (PV) cell and a touch panel (TP), an electrostatic dissipative (ESD) film and an electromagnetic interference (EMI) film. As the transparent conductive films, a film using indium tin oxide (ITO) has been used so far. However, there are problems of low supply stability of indium, high manufacturing cost, poor flexibility, and generation of much heat during film formation. Therefore, the study for a transparent conductive film in place of ITO has been actively promoted. Among the films, a transparent conductive film including a nanostructure is an optimal transparent conductive film as an ITO substitute in view of excellence in conductivity, optical characteristics and flexibility, capability of film formation with a wet process, low manufacturing cost and no need of high temperature during film formation. For example, a transparent conductive film that includes metal nanowires and has a high conductivity, optical characteristics, and flexibility is known (see Patent literature No. 1 and Non-patent literature No. 1, for example).

However, the transparent conductive film including the nanostructure has problems of low film hardness and poor environmental resistance due to easy reaction with various compounds. For example, a physical cleaning process using a brush or the like is applied in many cases in order to prevent a particulate impurity, dirt or dust from depositing or mixing onto a surface of a substrate, particularly in an application of an electronic material or the like. However, the surface is easily scratched in the process. Moreover, the nanostructure is easily corroded and the conductivity is easily decreased, due to the influence of various chemicals or a cleaning solution used in the process, the influence of oxygen or moisture in air to which the nanostructure is exposed during long-term storage, or the like.

In order to solve the problem described above, many attempts have been made to laminate a protective film onto the surface of the transparent conductive film including the nanostructure to provide the transparent conductive film with hardness and environmental resistance. Moreover, electrical connection of the wiring from an electronic circuit with the transparent conductive film is needed. Therefore, a protective film that can maintain the electrical contactability from the surface of the protective film to the transparent conductive film has been required.

As the protective film to be used for the transparent conductive film including the nanostructure, a protective film including a urethane resin for a transparent conductive film, a protective film containing a polyester polyamide acid and an epoxy resin for various optical materials, a protective film using inorganic silicon oxide, or the like has been known so far (Patent literature Nos. 1 to 5, for example). However, the protective films have not satisfied all of the characteristics described above.

### CITATION LIST

### Patent Literatures

Patent literature No. 1: JP 2010-507199 A.
Patent literature No. 2: JP 2008-156546 A.
Patent literature No. 3: JP 2009-205924 A.
Patent literature No. 4: JP 2011-204649 A.
Patent literature No. 5: JP 2011-102003 A.

### Non-Patent Literature

Non-patent literature No. 1: Shih-Hsiang Lai, Chun-Yao Ou, “SID 08 DIGEST,” 2008, pp. 1200-1202.

### SUMMARY OF INVENTION

In view of the background art as described, the invention provides a composition for forming a protective film that has good optical characteristics, and, while maintaining the electrical contactability with a transparent conductive film including a nanostructure, provides the transparent conductive film with high hardness and high environmental resistance.

The inventors have diligently continued to conduct research for solving the problems described above, and, as a result, have found that when a protective film is formed on a transparent conductive film including a nanostructure by using a thermosetting composition obtained by preparing a specific polyester amide acid, a specific epoxy resin, and a specific epoxy curing agent at a specific composition ratio, the problems can be solved. Furthermore, the present inventors have found that characteristics are improved by optimally adjusting the curing conditions and the additive component(s). The present inventors have diligently continued to conduct research based on the findings, as a result, have completed the invention.

The invention has a constitution as described below.

Item 1. A thermosetting composition for forming a protective film of a transparent conductive film including a nanostructure, containing:

polyester amide acid obtained from a reaction of a mixture containing tetracarboxylic dianhydride, diamine and a polyhydric hydroxy compound as a first component;
an epoxy resin as a second component;
an epoxy curing agent as a third component; and
a solvent as a fourth component,
wherein the first component is in the range of 0.5 to 2.5% by weight, the second component is in the range of 0.4 to 5% by weight, the third component is in the range of 0.1 to 0.7% by weight, and the fourth component is in the range of 91.8 to 99% by weight, based on the total amount of the composition.

Item 2. The thermosetting composition according to item 1, wherein the first component is a compound obtained from a reaction of a mixture containing 3,3′,4,4′-diphenyl ether tetracarboxylic dianhydride, 3,3′-diaminodiphenyl sulfone and 1,4-butanediol, and has a weight average molecular weight in the range of 1,000 to 50,000.

Item 3. The thermosetting composition of item 2, further containing benzyl alcohol in the mixture of the first component.

Item 4. The thermosetting composition according to any one of items 1 to 3, wherein the second component is an epoxy resin represented by formula (A) as shown below:

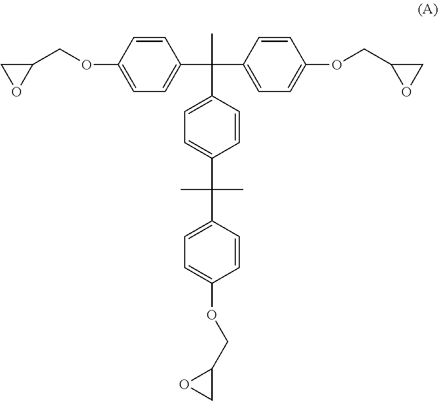 [SMILES: CC(C)(c1ccc(OCC2CO2)cc1)c1ccc(C(C)(c2ccc(OCC3CO3)cc2)c2ccc(OCC3CO3)cc2)cc1]

Item 5. The thermosetting composition according to any one of items 1 to 4, wherein the third component is trimellitic anhydride.

Item 6. The thermosetting composition according to any one of items 1 to 5, further containing a fluorine surfactant as a fifth component.

Item 7. The thermosetting composition according to item 6, wherein the fifth component is in the range of 3 to 6 parts by weight based on 100 parts by weight of the first component.

Item 8. The thermosetting composition according to any one of items 1-7, wherein the nanostructure is metal nanowires.

Item 9. The thermosetting composition according to item 8, wherein the nanostructure is silver nanowires.

Item 10. A method for forming a protective film of a transparent conductive film including a nanostructure, including:

a process 1 for applying the thermosetting composition according to any one of items 1 to 9 onto the transparent conductive film including the nanostructure; and
a process 2 for heating the thermosetting composition at a temperature in the range of 80° C. to 160° C.

Item 11. The method for forming the protective film according to item 10, wherein the temperature of the heating is in the range of 80° C. to 100° C. in the process 2.

Item 12. A protective film obtained by applying the method according to item 10 or 11, wherein the film thickness of the protective film is in the range of 40 to 150 nanometers.

Item 13. A laminate including the protective film according to item 12, a transparent conductive film including a nanostructure, and a substrate, wherein surface resistance of the transparent conductive film is in the range of 10Ω/□ to 500Ω/□, the total luminous transmittance of the laminate is 85% or more, and the haze of the laminate is 3% or less.

Item 14. An electronic device using the laminate according to item 13.

When a thermosetting composition according to a preferred embodiment of the invention is used as a protective film of a transparent conductive film including a nanostructure, the protective film has high optical characteristics, and, while maintaining the electrical contactability with the transparent conductive film, can provide the transparent conductive film with hardness and environmental resistance. Furthermore, the characteristics can be improved by optimally adjusting the curing conditions and the additive component(s). Therefore, the composition is particularly useful as the protective film of the transparent conductive film including the nanostructure.

### DESCRIPTION OF EMBODIMENTS

Hereafter, the invention will be specifically explained.

1. Thermosetting Composition

A thermosetting composition of the invention contains polyester amide acid obtained from a reaction of a mixture containing tetracarboxylic dianhydride, diamine and a polyhydric hydroxy compound as a first component, an epoxy resin as a second component, an epoxy curing agent as a third component, and a solvent as a fourth component. When the composition containing the components is thermally hardened, a three-dimensionally crosslinked structure is formed from the reaction of the amide groups included in the first component with the epoxy groups included in the second component, or from the reaction of the second component with the third component.

A protective film formed using the thermosetting composition of the invention has the features described below.

1) The protective film has good optical characteristics, i.e., a high transmittance and a low haze, due to the high flatness and the high uniformity of the protective film formed over the nanostructure.

2) The protective film has a sufficient hardness, heat resistance and shielding properties against a medical liquid or outdoor air (moisture, oxygen or the like) even with a small film thickness.

3) The protective film has good electrical contactability, due to the small film thickness thereof, and partial exposure of the underlying nanostructure on the surface thereof.

As a result, when the composition is applied as the protective film of the transparent conductive film including the nanostructure, the protective film can provide the transparent conductive film with an excellent hardness and environmental resistance, and can maintain high optical characteristics and electrical contactability with the transparent conductive film. Hereafter, each component will be explained in details.

1-1. Polyester Amide Acid

The first component contained in the thermosetting composition of the invention is polyester amide acid obtained from a reaction of a mixture containing a tetracarboxylic dianhydride, a diamine and a polyhydric hydroxy compound.

The polyester amide acid has a high heat resistance and a steric structure. Thereby, the heat resistance of the hardened film obtained, the hardness of the same, the shielding properties of the same against a medicinal solution or outdoor air (moisture, oxygen or the like), and so on are improved. Moreover, a part of the carboxyl groups and the amide groups in the molecules form imide bonds during calcination to improve the hardness and heat resistance of the hardened film obtained.

1-1-1. Tetracarboxylic Dianhydride

As tetracarboxylic dianhydride to be used in order to obtain the first component, various compounds can be used. Specific examples include 3,3′,4,4′-benzophenone tetracarboxylic dianhydride, 2,2′,3,3′-benzophenone tetracarboxylic dianhydride, 2,3,3′,4′-benzophenone tetracarboxylic dianhydride, 3,3′,4,4′-diphenylsulfone tetracarboxylic dianhydride, 2,2′,3,3′-diphenylsulfone tetracarboxylic dianhydride, 2,3,3′,4′-diphenylsulfone tetracarboxylic dianhydride, 3,3′,4,4′-diphenyl ether tetracarboxylic dianhydride, 2,2′,3,3′-diphenyl ether tetracarboxylic dianhydride, 2,3,3′,4′-diphenyl ether tetracarboxylic dianhydride, 2,2-[bis(3,4-dicarboxyphenyl)]hexafluoropropane dianhydride, ethylene glycol bis(anhydrotrimellitate) (trade name; TMEG-100, New Japan Chemical Co., Ltd.), cyclobutane tetracarboxylic dianhydride, methylcyclobutane tetracarboxylic dianhydride, cyclopentane tetracarboxylic dianhydride, cyclohexane tetracarboxylic dianhydride, ethane tetracarboxylic dianhydride and butane tetracarboxylic dianhydride. Among the compounds, from the viewpoint of the balance of the high transparency, the heat resistance and the hardness of the hardened film obtained, tetracarboxylic dianhydride having a diphenyl skeleton is preferred, and 3,3′,4,4′-diphenyl-sulfone tetracarboxylic dianhydride is most preferred.

1-1-2. Diamine

As diamine used in order to obtain the first component, various compounds can be used. Specific examples include 4,4′-diaminodiphenyl sulfone, 3,3′-diaminodiphenyl sulfone, 3,4′-diaminodiphenyl sulfone, bis[4-(4-aminophenoxy)phenyl]sulfone, bis[4-(3-aminophenoxy)phenyl]sulfone, bis[3-(4-aminophenoxy)phenyl]sulfone, [4-(4-aminophenoxy)phenyl][3-(4-aminophenoxy)phenyl]sulfone, [4-(3-aminophenoxy)phenyl][3-(4-aminophenoxy)phenyl]sulfone and 2,2-bis[4-(4-aminophenoxy)phenyl]hexafluoropropane. Among the compounds, from the viewpoint of the balance of the high transparency, the heat resistance and the hardness of the hardened film obtained, 3,3′-diaminodiphenyl sulfone is most preferred.

1-1-3. Polyhydric Hydroxy Compound

As the polyhydric hydroxy compound to be used in order to obtain the first component, various compounds can be used. Specific examples include ethylene glycol, diethylene glycol, triethylene glycol, tetraethylene glycol, polyethylene glycol having a molecular weight of approximately 1,000 or less, propylene glycol, dipropylene glycol, tripropylene glycol, tetrapropylene glycol, polypropylene glycol having a molecular weight of approximately 1,000 or less, 1,2-butanediol, 1,3-butanediol, 1,4-butanediol, 1,2-pentanediol, 1,5-pentanediol, 2,4-pentanediol, 1,2,5-pentanetriol, 1,2-hexanediol, 1,6-hexanediol, 2,5-hexanediol, 1,2,6-hexane triol, 1,2-heptanediol, 1,7-heptanediol, 1,2,7-heptanetriol, 1,2-octanediol, 1,8-octanediol, 3,6-octanediol, 1,2,8-octanetriol, 1,2-nonanediol, 1,9-nonanediol, 1,2,9-nonanetriol, 1,2-decanediol, 1,10-decanediol, 1,2,10-decanetriol, 1,2-dodecanediol, 1,12-dodecanediol, glycerol, trimethylolpropane, pentaerythritol, dipentaerythritol, bisphenol A (trade name), bisphenol S (trade name), bisphenol F (trade name), diethanolamine and triethanolamine. Among the compounds, from the viewpoint of ease of the synthesis of the first component, ethylene glycol, propylene glycol, 1,4-butanediol, 1,5-pentanediol, 1,6-hexanediol, 1,7-heptane diol and 1,8-octanediol are preferred, and 1,4-butanediol, 1,5-pentanediol and 1,6-hexanediol are particularly preferred.

1-1-4. Monohydric Alcohol

The thermosetting composition preferably further contains a monohydric alcohol in addition to the compounds described above in order to obtain the first component, because the molecular weight is easy to control by doing so.

As such a monohydric alcohol, various compounds can be used. Specific examples include methanol, ethanol, 1-propanol, isopropyl alcohol, allyl alcohol, benzyl alcohol, hydroxyethyl methacrylate, propylene glycol monoethyl ether, propylene glycol monomethyl ether, dipropylene glycol monoethyl ether, dipropylene glycol monomethyl ether, ethylene glycol monoethyl ether, ethylene glycol monomethyl ether, diethylene glycol monoethyl ether, diethylene glycol monoethyl ether, phenol, borneol, maltol, linalool, terpineol, dimethylbenzyl carbinol and 3-ethyl-3-hydroxymethyloxetane. Among the compounds, when isopropyl alcohol, allyl alcohol, benzyl alcohol, hydroxyethyl methacrylate, propylene glycol monoethyl ether or 3-ethyl-3-hydroxymethyloxetane is used, synthesis of the first component is easy, and the applicability on the transparent conductive film including the nanostructure gets satisfactory. Among the compounds, benzyl alcohol is most preferred.

1-1-5. Other Compound as Raw Material of the 1^{st} Component

In addition thereto, the thermosetting composition may further contain various compounds in order to obtain the first component. When the thermosetting composition contains other compound(s), the steric structure, the weight average molecular weight and so on of the first component can be controlled, and the applicability on the transparent conductive film including the nanostructure, or the balance of the hardness, the shielding properties and so on of the hardened film obtained, can be controlled. For example, when the thermosetting composition further contains a styrene-maleic anhydride polymer or the like, the viscosity of the composition can be finely adjusted, and the applicability on the transparent conductive film including the nanostructure can be improved, while the hardness, the shielding properties and so on of the hardened film obtained are maintained.

1-1-6. Composition of the Mixture

Polyester amide acid is obtained from the reaction of the mixture containing compounds suitably selected from the compounds exemplified above. Among the compounds, a polyester amide acid obtained from a reaction of a mixture containing 3,3′,4,4′-diphenyl ether tetracarboxylic dianhydride, 3,3′-diaminodiphenyl sulfone, 1,4-butanediol and benzyl alcohol is most preferred. Use of the polyester amide acid as the first component of the thermosetting composition of the invention is preferred because the hardness, the environmental resistance, the shielding properties and so on of the hardened film obtained are excellent.

The polyester amide acid is prepared from a mixture in which, at a preferred ratio of compounding the tetracarboxylic dianhydride, the diamine and the polyhydric hydroxy compound, the diamine is compounded in approximately 10 to approximately 50 parts by mole and the polyhydric hydroxy compound compounded in approximately 50 to approximately 70 parts by mole, based on 100 parts by mole of the tetracarboxylic dianhydride. Use of the polyester amide acid as the first component of the thermosetting composition of the invention is preferred because the applicability of the composition and the hardness, the shielding properties and so on of the hardened film obtained are excellent.

1-1-7. Method for Synthesizing Polyester Amide Acid

A method for synthesizing the polyester amide acid is not particularly limited, but it is preferred to disperse the mixture containing the tetracarboxylic dianhydride, the diamine and the polyhydric hydroxy compound as exemplified above in a solvent and react the same. The reaction solvent is not particularly limited, if only it can disperse the compounds as the raw materials. Examples thereof include diethylene glycol dimethyl ether, diethylene glycol diethyl ether, diethylene glycol monoethyl ether acetate, ethylene glycol monomethyl ether acetate, propylene glycol monomethyl ether acetate, methyl 3-methoxypropionate, propylene glycol monoethyl ether acetate, and N-methyl-2-pyrrolidone. Among the solvents, use of methyl 3-methoxypropionate, propylene glycol monomethyl ether acetate or a mixture thereof as the solvent is most preferred from the viewpoint of ease of the synthesis and ease of the preparation of the thermosetting composition of the invention. The first component is preferably prepared from the reaction in the solvents at approximately 40° C. to approximately 200° C. for approximately 1 to approximately 24 hours.

A weight average molecular weight of polyester amide acid in the range of approximately 1,000 to approximately 50,000 is preferred from the viewpoint of applicability of the composition and uniformity of the hardened film obtained. If the molecular weight is in the range, the surface flatness and the shielding properties of the hardened film are satisfactory, and therefore the optical characteristics and the electrical contactability become satisfactory.

In addition, “weight average molecular weight” herein means a standard polystyrene equivalent weight average molecular weight measured by GPC. Herein, the GPC measurement is carried out by using polystyrene having a weight average molecular weight in the range of 645 to 132,900 (for example, Polystyrene Calibration Kit PL2010-0102 as a trade name, from VARIAN, Inc.) for a standard polystyrene, PLgelMIXED-D (trade name, from VARIAN, Inc.) for a column, and THF as a mobile phase, under the conditions of a column temperature of 35° C. and a flow rate of 1 mL/min.

1-2. Epoxy Resin

The thermosetting composition of the invention contains an epoxy resin as the second component. Upon thermally hardening of the thermosetting composition of the invention, a three-dimensionally crosslinked structure is formed by a reaction of the first component with the second component or a reaction between the second components, and the heat resistance, the hardness, the moisture-shielding property and so on of the hardened film obtained are improved.

The epoxy resin that can be used as the second component is not particularly limited. However, a multifunctional polymer type epoxy resin, a polyfunctional monomer type epoxy resin, an alicyclic epoxy resin, a glycidyl ester type epoxy resin or the like that contributes to improvement of the hardness and the shielding properties of the hardened film obtained is preferred. Among the resins, from the viewpoint of the hardness and the environmental resistance of the hardened film obtained, a multifunctional polymer type epoxy resin and a polyfunctional monomer type epoxy resin are preferred. Among the resins, use of 2-[4-(2,3-epoxypropoxy)phenyl]-2-[4-[1,1-bis[4-([2,3-epoxypropoxy]phenyl)]ethyl]phenyl]propane as a polyfunctional monomer type epoxy resin is most preferred because the environmental resistance of the hardened film obtained is particularly satisfactory.

Specific examples of the commercial products include polyfunctional monomer type epoxy resins such as VG-3101L (trade name, from Printec Co., Ltd.), HP-4700 and HP-4710 (trade names, from DIC, Inc.) and EOCN-104S and EPPN-201 (trade names, from Nippon Kayaku Co., Ltd.), and multifunctional polymer type epoxy resins such as HP-7200HH (trade name, from DIC, Inc.). Among the resins, from a similar viewpoint as described above, VG-3101L is most preferred.

1-3. Epoxy Curing Agent

The thermosetting composition of the invention contains an epoxy curing agent as the third component. The third component is effective in promoting the curing of the epoxy resin as the second component, and contributes to improvement of the hardness, the shielding properties and so on of the hardened film obtained.

As the epoxy curing agent, any of generally known curing agents can be used. Specific examples thereof include aliphatic polyamines such as diethylene triamine, triethylene tetramine, tetraethylene pentamine, diethylaminopropylamine, N-aminoethylpiperazine and menthane diamine; aromatic amines such as meta-phenylene diamine, diaminodiphenylmethane and diaminodiphenyl sulfone; imidazoles such as 2-methylimidazole and 2-ethyl-4-methylimidazole; polyamide resins; polysulfide resins; and acid anhydrides such as phthalic anhydride, trimellitic anhydride, pyromellitic dianhydride, benzophenone tetracarboxylic anhydride, ethylene glycol bistrimellitate, glycerol tristrimellitate, maleic anhydride, tetrahydrophthalic anhydride, hexahydrophthalic anhydride, succinic anhydride, methylcyclohexene dicarboxylic anhydride, and styrene-maleic anhydride. Among the compounds, if an acid anhydride is used, the hardening properties are satisfactory and the acid anhydride contributes to improvement of the hardness, the shielding properties and so on of the hardened film obtained. In particular, from the viewpoint of reactivity and ease of the preparation of the composition, use of trimellitic anhydride is most preferred.

1-4. Solvent

The thermosetting composition of the invention contains a solvent as the fourth component. The fourth component favorably disperses the first component to the third component, and contributes to formation of a uniform film upon application and film formation.

As the solvent, any solvent dissolving the constituents of the composition can be used. From the viewpoint of small influence on the transparent conductive film including the nanostructure, use of propylene glycol monomethyl ether, propylene glycol monomethyl ether acetate, methyl 3-methoxypropionate, propylene glycol monoethyl ether acetate, or a mixture thereof is preferred. Moreover, the solvent used upon the preparation of the first component can be directly used, and the case has an advantage of ease of controlling the physical properties of the composition.

1-5. Additive Components

### 1-5-1. Surfactant

The thermosetting composition of the invention may also contain a surfactant as an additive component. The surfactant is effective in further improving the applicability of the thermosetting composition of the invention on the transparent conductive film including the nanostructure. As a result, the uniformity of the hardened film obtained becomes satisfactory, and the shielding properties and so on of the hardened film are improved.

As the surfactant, a generally known silicone, fluorine or acrylic surfactant can be used. Specific examples of the commercial products include Zonyl FSO-100, Zonyl FSN, Zonyl FSO and Zonyl FSH (trade names, from E. I. du Pont de Nemours & Co.), Triton X-100, Triton X-114 and Triton X-45 (trade names, from Sigma-Aldrich Japan K. K.), Dynol 604 and Dynol 607 (trade names, from Air Products and Chemicals Japan, Inc.), n-Dodecyl-β-D-maltoside, Novek, Byk-300, Byk-306, Byk-335, Byk-310, Byk-341, Byk-344, Byk-370, Byk-354, Byk-358 and Byk-361 (trade names, from BYK-Chemie Japan K. K.), DFX-18, Futargent 250 and Futargent 251 (trade names, from Neos Co., Ltd.), F-477, F-479, F-472SF and TF-1366 (trade names, from DIC, Inc.), and KP-341 (trade name, from Shin-Etsu Chemical Co., Ltd.), but are not limited thereto. Moreover, the surfactant may be used in one kind or in combination of two or more kinds. Among the surfactants, if the fluorine surfactant is used, the optical characteristics, the electrical contactability and the environmental resistance of the hardened film are superior. The reason is assumed that use of the surfactant improves the applicability on the transparent conductive film including the nanostructure, and thus the flatness and shielding properties of the hardened film are improved. Moreover, the use of the surfactant has an advantage of an excellent applicability of the composition when a film is formed by further applying a different composition onto the hardened film obtained. As a result, addition of the fluorine surfactant to the thermosetting composition of the invention is further preferred.

The content of the surfactant is preferably in the range of approximately 1 to approximately 10 parts by weight based on 100 parts by weight of the first component. A content in the range of approximately 3 to approximately 6 parts by weight is most preferred because the applicability on the transparent conductive film including the nanostructure is excellent. If the content is in the above range, an effect of sufficiently improving the applicability is obtained, and applicability of the different composition also becomes satisfactory when the film is formed by further applying the different composition on the hardened film obtained.

1-5-2. Other Additive Components

The thermosetting composition of the invention may also contain, when necessary, other compounds such as a close-contact accelerator, a corrosion inhibitor and a polymerization inhibitor in order to further improve various characteristics.

As the close-contact accelerator, a compound that forms a bond between a substrate and a component in the composition, a compound that has a functional group showing affinity between the substrate and the component in the composition, and so on are known. Moreover, close contact may be promoted with a different close-contact accelerator based on a different mechanism.

Specific examples of the close-contact accelerator include silane coupling agents such as 3-(3-aminopropyl)triethoxysilane, 3-(3-mercaptopropyl)trimethoxysilane, 3-methacryloyloxy propyltrimethoxysilane and 3-glycidoxypropyltrimethoxysilane, but are not limited thereto. Moreover, the close-contact accelerator may be used in one kind or in combination of two or more kinds.

As the corrosion inhibitor, a well known compound such as a hindered amine compound or a hindered phenol compound can be used. Moreover, the corrosion inhibitor may be used in one kind or in combination of two or more kinds. Specific examples of the commercial products include Irgafos XP 40, Irgafos XP 60, Irganox 1010, Irganox 1035, Irganox 1076, Irganox 1135 and Irganox 1520L (trade names, from BASF Japan Ltd.)

As the polymerization inhibitor, a well known compound such as a compound of hydroquinone, phenol or quinone type can be used. Moreover, the polymerization inhibitor may be used in one kind or in combination of two or more kinds. Specific examples thereof include hydroquinone monomethyl ether, 4-methoxyphenol, hydroquinone and naphthoquinone.

2. Composition of the Thermosetting Composition

As for the thermosetting composition of the invention, the composition ratio for the first to the fourth components is set in a specific range. Thus, when the protective film of the transparent conductive film including the nanostructure is formed using the composition, the protective film can provide the transparent conductive film with a high hardness and a high environmental resistance while maintaining the high optical characteristics and excellent electrical contactability with the transparent conductive film.

Specifically, the thermosetting composition of the invention contains the first component in the range of approximately 0.5 to approximately 2.5% by weight, the second component in the range of approximately 0.4 to approximately 5% by weight, the third component in the range of approximately 0.1 to approximately 0.7 part by weight and the fourth component in the range of approximately 92 to approximately 99% by weight, based on the total amount of the composition. If the composition ratio is in the range, the application and film formation can be performed on the transparent conductive film including the nanostructure with a good applicability by applying a general application method, and the protective film can be formed having high optical characteristics, maintaining the electrical contactability with the transparent conductive film, and providing the transparent conductive film with a high hardness and a high environmental resistance.

If the content of the first component is overly large, the hardness and the transparency of the hardened film are decreased. Therefore, such content is not preferred from the viewpoint of the hardness and the optical characteristics of the protective film. If the content of the first component is overly small, the heat resistance, the shielding properties and the flatness are decreased. Therefore, such content is not preferred from the viewpoint of the optical characteristics and the environmental resistance of the protective film.

If the content of the second component is overly large, the residual monomer component after the composition is hardened is increased. Therefore, such content is not preferred from the viewpoint of the environmental resistance of the protective film. If the content of the second component is overly small, the shielding properties, the flatness and the hardness of the hardened film are decreased. Therefore, such content is not preferred from the viewpoint of the optical characteristics and the hardness of the protective film.

When the composition ratio of the first component to the second component, and the composition ratio of the second component to the third component respectively satisfy the composition ratios described above, the balance of reactivity between individual components during calcination is satisfactory, and the composition ratios are preferred from the viewpoint of the hardness and the environmental resistance of the protective film.

If the content of the fourth component based on the first component to the third component is overly small, the thickness of the hardened film is easily increased, and the shielding properties are decreased by generation of cracks on the protective film due to the difference in thermal shrinkage between the transparent conductive film and the protective film during the calcination. Hence, such content is not preferred from the viewpoint of the electrical contactability and the environmental resistance of the protective film. Moreover, if the content of the fourth component based on the first to third component is overly large, the heat resistance, the shielding properties and the flatness of the hardened film are decreased. Therefore, such content is not preferred from the viewpoint of the optical characteristics and the environmental resistance of the protective film.

The thermosetting composition of the invention can be manufactured at the composition ratio of the components and by appropriately selecting agitation, mixing, heating, cooling, dissolution or the like according to well known methods.

3. Method for Forming the Protective Film Using the Thermosetting Composition

A method for forming the protective film on the transparent conductive film including the nanostructure using the thermosetting composition will be explained below.

3-1. Transparent Conductive Film

“Transparent conductive film” of the invention means a film having a surface resistance of approximately 10⁴Ω/□ or less, and a total luminous transmittance of approximately 80% or more. As the transparent conductive film, any film may be applied if only the film has transparency and conductivity. However, the transparent conductive film includes a nanostructure from the viewpoint of the conductivity, the optical characteristics, manufacturing cost, flexibility, and needlessness of a high temperature during film formation.

“Nanostructure” of the invention means a structure that satisfies the following conditions:

(1) having approximately 1 micrometer or less in at least one element of the shape dimension;
(2) having a predetermined regularity of shape; and
(3) comprising a single compound or an aggregate,
and has conductivity.

As for the shape dimension, at least one element such as the length or the size may be approximately 1 micrometer or less. For example, when a cylindrical structure has a diameter of approximately 1 micrometer or less, the length may be approximately 1 micrometer or more.

“Nanowire” of the invention means the nanostructure, and is a wire-shaped or tube-shaped conductive material, which may be linear or gently or steeply bent. In a case of tube shape, the nanowire may be porous or nonporous. The nanowire may be flexible or rigid. Specific examples of the material of the nanowire include: at least one metal selected from the group consisting of gold, silver, platinum, copper, nickel, iron, cobalt, zinc, ruthenium, rhodium, palladium, cadmium, osmium and iridium, and alloys as combinations of the metals. From the viewpoint of obtaining a coating film having a low surface resistance and a high total luminous transmittance, the nanowire preferably includes at least one of gold, silver and copper. Because the metals have high conductivity, the density of the metal on a surface can be reduced upon obtaining a desired surface resistance, and thus a high transmittance can be made. Among the metals, the nanowires preferably include at least one of gold and silver. In a preferred embodiment, silver is preferred. The lengths of the nanowires in the minor axis, the length of the same in a major axis, and the aspect ratio each have a certain distribution. The distribution is selected from the viewpoint that the coating obtained from the composition of the invention is high in the total luminous transmittance and low in the surface resistance. Specifically, the average of the lengths of the nanowires in the minor axis is preferably in the range of approximately 1 nanometer to approximately 500 nanometers, more preferably in the range of approximately 5 nanometers to approximately 200 nanometers, still more preferably in the range of approximately 5 nanometers to approximately 100 nanometers, and particularly preferably in the range of 10 nanometers to 100 nanometers. Moreover, the average of the lengths of the nanowires in the major axis is preferably in the range of approximately 1 micrometer to approximately 100 micrometers, more preferably in the range of approximately 1 micrometer to approximately 50 micrometers, still more preferably in the range of approximately 2 micrometers to approximately 50 micrometers, and particularly preferably in the range of approximately 5 micrometers to approximately 30 micrometers. For the nanowires, the average of the lengths thereof in the minor axis and the average of the lengths thereof in the major axis are preferably in the above ranges, and the average of the aspect ratio is preferably larger than 1 approximately, more preferably larger than 10 approximately, still more preferably larger than 100, and particularly preferably larger than 200 approximately. Herein, “aspect ratio” is a value determined from a/b when the average length of the nanowires in the minor axis is approximated as “b” and the average length of the nanowires in the major axis is approximated as “a”. Then, “a” and “b” can be measured using a scanning electron microscope.

The transparent conductive film may be formed on at least one side of a substrate such as glass. Hereinafter, the substrate on which such a transparent conductive film is formed is occasionally abbreviated as “transparent conductive film substrate.” The substrate may be rigid or easily bent. Moreover, the substrate may be colored. Specific examples of the material of the substrate include glass, polyimide, polycarbonate, polyethersulfone, acryloyl, polyester, polyethylene terephthalate, polyethylene naphthalate, polyolefin and polyvinyl chloride. The material preferably has a high luminous transmittance and a low haze value. On the substrate, a circuit such as a TFT device may be formed and an organic functional material such as a color filter and an overcoat, or an inorganic functional material such as a silicon nitride film or a silicon oxide film may be formed. Moreover, a number of layers may be laminated on the substrate.

The surface resistance of the transparent conductive film including the nanostructure is properly determined according to the application, but the transparent conductive films in the range of approximately 10Ω/□ to approximately 1,000Ω/□ have been used in many cases. The surface resistance is determined by the film thickness and surface density of the nanostructure. A larger film thickness is better from the viewpoint of a low surface resistance, and a smaller film thickness is better from the viewpoint of the optical characteristics. Therefore, when the facts are comprehensively taken into consideration, the film thickness is preferably in from approximately 5 nanometers to approximately 500 nanometers, more preferably from approximately 5 nanometers to approximately 200 nanometers, and still more preferably from approximately 5 nanometers to approximately 100 nanometers.

In the invention, unless otherwise noted, the surface resistance is expressed in terms of a value measured according to a non-contact measurement method as described later.

Method for Forming the Protective Film

Hereinafter, a method for forming the protective film on the transparent conductive film including the nanostructure by using the thermosetting composition of the invention will be explained in details by way of examples in which a transparent conductive film substrate is used.

Process 1 for Applying the Thermosetting Composition of the Invention onto the Transparent Conductive Film Substrate

First, the thermosetting composition of the invention is applied onto the transparent conductive film substrate including the nanostructure. As an application method, a general method can be applied, such as a spin coating method, a slit coating method, a dip coating method, a blade coating method, a spray method, a relief printing method, an intaglio printing method, a planographic printing method, a dispensing method and an ink jet method. From the viewpoint of the film thickness uniformity and the productivity, the spin coating method and the slit coating method are preferred, and the slit coating method is more preferred.

An appropriate drying process is preferably conducted to the substrate after the application process. In the drying process, the substrate is dried on a hot plate or in an oven to remove the solvent in the coating film. The solvent does not need to be completely removed. The drying is ordinarily performed under the conditions of approximately 60° C. to approximately 120° C. and approximately 1 minute to approximately 5 minutes, although the conditions depend on the kind of the solvent. The drying conditions of approximately 80° C. and approximately 1 minute to approximately 5 minutes are preferred from the viewpoint of the manufacturing cost and the thermal load to the transparent conductive film including the nanostructure.

Process 2 for Thermally Hardening the Thermosetting Composition

Next, the substrate is calcinated on the hot plate or in the oven. The solvent in the coating film is removed by the process, and the coating film is hardened due to the reaction of the first to the third components. As a result, a high hardness and a high environmental resistance are provided for the transparent conductive film, while the electrical contactability with the transparent conductive film including the nanostructure is maintained. Moreover, the hardened film has high optical characteristics. In the process, reacting all the groups in the composition is not necessary, and reacting only a part of the groups is feasible.

A calcination temperature is ordinarily approximately 80° C. to approximately 250° C., although depending on the composition. A temperature in the range of approximately 80° C. to approximately 160° C. is preferred from the viewpoint of the environmental resistance of the transparent conductive film because the thermal load on the transparent conductive film including the nanostructure is reduced. A temperature in the range of approximately 80° C. to approximately 100° C. is most preferred from a similar viewpoint.

In addition, a suitable treatment process, a suitable cleaning process and a suitable drying process may be appropriately applied before and after each process described above. Specific examples of the treatment processes include plasma surface treatment, ultrasonic treatment, ozone treatment, cleaning treatment using a suitable solvent, and heating treatment. Moreover, a process of immersion into water may be applied.

The plasma surface treatment can be applied to improve the wettability of the coating forming composition, a developer or the like. For example, the surface of the substrate or the coating forming composition thereon can be treated under the conditions of approximately 100 W, approximately 90 seconds, an oxygen flow rate of approximately 50 sccm (standard cc/min) and a pressure of approximately 50 Pa by using oxygen plasma. In the ultrasonic treatment, particulates or the like physically deposited on the substrate can be removed by immersing the substrate into a solution, and propagating ultrasonic waves of approximately 200 kHz, for example. In the ozone treatment, a deposit or the like on the substrate can be effectively removed by blowing air onto the substrate and simultaneously irradiating the substrate with ultraviolet light and utilizing the oxidizing power of ozone generated by the ultraviolet light. In the cleaning treatment, a particulate impurity can be washed out and removed by spraying pure water in a mist form or a shower form and utilizing the dissolving capability and the pressure of the pure water, for example. The heat treatment is a method for removing a compound to be desirably removed from the substrate by volatilizing the compound. The heating temperature is appropriately set in consideration of the boiling point of the compound to be desirably removed. For example, when the compound to be desirably removed is water, the substrate is heated at a temperature in the range of approximately 50° C. to approximately 80° C.

As for the surface resistance and the total luminous transmittance of the transparent conductive film substrate having the protective film as obtained by applying the manufacturing method as described above, the surface resistance is preferably in the range of approximately 1Ω/□ to approximately 1,000Ω/□ and the total luminous transmittance is preferably in the range of approximately 80% or more. The surface resistance is more preferably in the range of approximately 10Ω/□ to approximately 500Ω/□ and the total luminous transmittance is more preferably in the range of approximately 85% or more.

Herein, “total luminous transmittance” is the ratio of the transmitted light to the incident light, and the transmitted light includes a directly transmitted component and a scattered component. The light source is illuminant C and the spectrum is a CIE luminosity function: y.

The film thickness of the protective film is in the range of approximately 40 nanometers to approximately 150 nanometers, preferably in the range of approximately 40 nanometers to approximately 100 nanometers. It is preferred if the film thickness is in the range, because the optical characteristics of the protective film, the hardness and the environmental resistance to be provided for the transparent conductive film including the nanostructure, and the electrical contactability with the transparent conductive film are excellently balanced.

4. Application of the Protective Film Using the Thermosetting Composition

The transparent conductive film having the protective film (hereinafter, occasionally abbreviated as a transparent conductive film with the protective film or a transparent electrode with the protective film) as formed using the thermosetting composition of the invention is used for an electronic device in view of the conductivity of the film and the optical characteristics thereof.

Specific examples of the electronic device include a liquid crystal display device, an organic electroluminescence display, an electronic paper, a touch panel device and a photovoltaic cell device.

The electronic device may be prepared using a stiff substrate, a flexible substrate, or a combination thereof. Moreover, the substrate used for the electronic device may be transparent or colored.

Examples of the transparent conductive film with the protective film used for the liquid crystal display device include a pixel electrode formed on a side of a substrate of a thin film transistor (TFT) array and a common electrode formed on a side of a color filter substrate. Specific examples of the display modes of LCD include twisted nematic (TN), multi vertical alignment (MVA), patterned vertical alignment (PVA), in plane switching (IPS), fringe field switching (FFS), polymer stabilized vertical alignment (PSA), optically compensated bend (OCB), continuous pinwheel alignment (CPA) and blue phase (BP) modes. Moreover, transmissive type, reflective type and transflective type display devices are included for each of the modes. A pixel electrode of an LCD is defined for each pixel, and is electrically connected with a drain electrode of a TFT. In addition, for example, the IPS mode has a comb electrode structure, and the PVA mode has a slit structure in the pixel.

The transparent conductive film with the protective film used for the organic electroluminescence display is ordinarily subjected to patterning in a stripe form on the substrate when the film is used as a conductive region in a passive driving mode. A direct current voltage is applied between a conductive region (anode) in a stripe form and another conductive region (cathode) in a stripe form arranged orthogonally thereto to allow pixels in a matrix form to emit light and display an image. When the film is used as an electrode in an active driving mode, the film is subjected to patterning for each pixel on a side of a TFT-array substrate.

The touch panel devices include the resistive type and the capacitive type depending on the detection method, and the transparent electrode with the protective film is used for any of types. The transparent electrode with the protective film used for the capacitive type is subjected to patterning.

The electronic paper includes the microcapsule type, the quick response liquid powder type, the liquid crystal type, the electrowetting type, the electrophoretic type and the chemical change type depending on the display method, and the transparent electrode with the protective film is used for any of types. The transparent electrode with the protective film is subjected to patterning in an arbitrary shape in any of types.

The photovoltaic cell devices includes the silicon type, the compound type, the organic type and the quantum dot type depending on the material of the optical absorption layer, and the transparent electrode with the protective film is used for any of types. The transparent electrode with the protective film is subjected to patterning in an arbitrary shape in any of types.

It will be apparent to those skilled in the art that various modifications and variations can be made in the invention and the following specific examples provided herein without departing from the spirit or scope of the invention.

### EXAMPLES

In the following, the invention will be explained in greater detail by way of Examples, but the invention is in no way limited to the Examples. In the Examples and Comparative Examples, ultrapure water was used as the water being a constituent. However, ultrapure water may be referred to simply as water below. Ultrapure water was prepared using Puric FPC-0500-0M0 (trade name, from Organo Corporation).

The measurement methods or the evaluation methods in each evaluation item were applied in a manner as described below.

Unless otherwise noted, measurement (1) to measurement (6) were carried out in a region in which a transparent conductive film existed in any sample to be evaluated.

(1) Measurement of Surface Resistance

As the evaluation methods, two types, namely, a four-point probe method and a non-contact measurement method can be applied.

Loresta-GP MCP-T610 (Mitsubishi Chemical Corporation) was used for the four-point probe measurement method (in accordance with JIS K7194). A probe used for measurement is a specified ESP probe having an inter-pin distance of 5 mm and a pin point diameter of 2 mm. The surface resistance (Ω/□) was calculated by bringing the probe into contact with a sample to be evaluated to measure the potential difference between two inner terminals when passing a fixed electric current through two outer terminals, and multiplying the measured resistance value by a correction coefficient. Hereafter, the thus obtained surface resistance value is occasionally expressed as “Rs (contact).”

As the non-contact measurement method, a non-contact surface resistance measurement method using an eddy current was applied. Specifically, the surface resistance (Ω/□) was measured using 717B-H (DELCOM, Inc.). Hereinafter, the thus obtained surface resistance value is occasionally expressed as “Rs (non-contact).”

In addition, unless otherwise noted, the surface resistance herein is expressed in terms of the measured value obtained by applying the non-contact measurement method.

(2) Measurements of Total Luminous Transmittance and Haze

Haze-Gard Plus (BYK Gardner, Inc.) was used for the measurements of the total luminous transmittance and the haze. Air was used as a reference.

(3) Testing of Environmental Resistance

A transparent conductive film was placed still in a mini environment testing equipment SH-641 (trade name, from ESPEC Corporation), and an inside of the testing equipment was kept under fixed conditions of a temperature of 70° C. and a humidity of 90% RH. After 300 hours under the conditions, the transparent conductive film was taken out, the surface resistance, the total luminous transmittance and the haze thereof were measured, and then the environmental resistance was evaluated by comparing the measured values with the initial values.

With respect to the evaluation results, when the variations of all the characteristics including the surface resistance, the total luminous transmittance and the haze were in the range of 0% to 5% as compared to the initial values, the sample was rated to be “excellent (OO)”, when the variations of all the characteristics were in the range of 0% to 10% and that of at least one of the characteristics was in the range of 6% to 10%, the sample was rated to be “slightly good (O)”, and when the variation of at least one of the characteristics was 11% or more, the sample was rated to be “poor (XX)”.

(4) Hardness

In the measurement of hardness, testing was conducted using each type of pencils from 6B to 2H by using a tester in accordance with “Pencil scratch tester for a paint film (JIS K5401)”. The film surface after the testing of a sample to be evaluated was visually observed, and whether or not a coating film was broken was evaluated.

In the evaluation, when the hardest pencil without causing break of the coating film was 2H or harder, the sample was rated to be “excellent (OO)”, when such a pencil was 6B or harder and softer than 2H, the sample was rated to be “somewhat poor (X)”, and when flaking was caused with all pencils, the sample was rated to be “poor (XX)”.

(5) Film Thickness

In the measurement of film thickness, Profilometer P-16+ (trade name, from KLA-Tencor Corporation) was used. Specifically, a hardened film of a composition as a measurement object was formed, in a similar manner and under similar conditions in each Example, on glass having a substrate surface subjected to UV ozone treatment by irradiation with ultraviolet light having an irradiation energy of 1,000 mJ/cm² (low pressure mercury lamp (254 nanometers)). Then, a part of the film was shaved off, and the profile on a boundary surface was measured. The measured value of the profile was described as the film thickness of the object sample in each Example. In addition, the film thickness was measured in accordance with “Test method for thickness of fine ceramic thin films—Film thickness by contact probe profilometer” (JIS R1636).

(6) Contactability

The contactability was evaluated by measuring the surface resistance and comparing the measured values of the contact Rs and the non-contact Rs. In the comparison of the contact Rs and the non-contact Rs, when the difference therebetween was less than 10%, the sample was rated to be “excellent (OO)”, when the difference therebetween was 10% or more and less than 30%, the sample was rated to be “slightly good (O)”, and when the difference therebetween was 30% or more, the sample was rated to be “poor (XX)”.

The composition for forming the transparent conductive film, and the substrate on which the transparent conductive film was formed (hereinafter, occasionally referred to as a transparent conductive film substrate) that were used in the Examples and Comparative Examples were prepared based on the description in Example 17 as disclosed in JP 2010-507199 A.

Synthesis of Silver (Ag) Nanowires

In a 1,000 mL flask, 4.171 g of poly(N-vinylpyrrolidone) (trade name: Polyvinylpyrrolidone K30, MW: 40,000, Tokyo Kasei Kogyo Co., Ltd.), 70 mg of tetrabutylammonium chloride (Wako Pure Chemical Industries, Ltd.), 4.254 g of silver nitrate (Wako Pure Chemical Industries, Ltd.) and 500 mL of ethylene glycol (Wako Pure Chemical Industries, Ltd.) were loaded, and the resultant mixture was agitated for 15 minutes and uniformly dissolved, and was then agitated at 110° C. for 16 hours in an oil bath. A solution including Ag-nanowires was thus obtained.

Subsequently, the solution was returned to room temperature (25 to 30° C.), and then centrifuged by means of a centrifuge (As One Corporation). The reaction solvent was replaced with water to obtain an aqueous solution in which the silver nanowires were dispersed. Through the operation, the unreacted silver nitrate, poly(N-vinylpyrrolidone) as a template, tetrabutylammonium chloride, ethylene glycol and silver nanoparticles having a small particle size in the solution were removed. A 1 wt % silver nanowires dispersion aqueous solution was obtained by filtering the solution and redispersing precipitates on the filter paper into water. The mean values of the lengths of the silver nanowires in the minor axis and in the major axis and the aspect ratios of the same were 45 nanometers, 18 micrometers and 400, respectively.

Preparation of Binder Solution

In a 300 mL beaker whose tare weight was premeasured, 100 g of ultrapure water was loaded and subjected to heating agitation. At a liquid temperature of 80 to 90° C., 2.00 g of hydroxypropyl methyl cellulose (trade name: Metolose 90SH-10000, Shin-Etsu Chemical Co., Ltd., viscosity of a 2 wt % aqueous solution: 100,000 mPa·s, occasionally abbreviated as HPMC hereafter) was added slowly, and the resultant mixture was strongly agitated to uniformly disperse HPMC. While the strong agitation was kept, 80 g of ultrapure water was added, and the heating was stopped simultaneously. The agitation was continued while the beaker was cooled with ice water, until a uniform solution was formed. After 20 minutes of agitation, ultrapure water was added to form 200.00 g of an aqueous solution, and agitation was further continued for 10 minutes at room temperature until a uniform solution was formed. Thus, a 1 wt % binder solution was prepared.

Preparation of Composition for Forming Transparent Conductive Film

Then, 17.1 g of 1 wt % binder solution, 17.1 g of 1 wt % silver nanowires dispersion aqueous solution, 1.71 g of an aqueous solution having 0.1 wt % of Triton X-100 (trade name, from Sigma-Aldrich Japan, Inc.) and 49.6 g of ultrapure water were weighed, the resultant mixture was agitated until a uniform solution was formed. Thus, a composition for forming a transparent conductive film with a composition ratio as described below was obtained.

| | |
|---|---|
| Silver nanowires | 0.20 wt % |
| HPMC | 0.20 wt % |
| Triton X-100 | 0.002 wt % |
| Water | 99.598 wt % |

Preparation of Transparent Conductive Film Substrate

Then, 1 mL of the above-obtained composition for forming a transparent conductive film was added dropwise on 0.7 mm-thick Eagle XG glass (trade name, from Corning, Inc.) having a substrate surface subjected to UV ozone treatment by irradiation with ultraviolet light having an irradiation energy of 1,000 mJ/cm² (low-pressure mercury lamp (254 nm)), and spin coating was performed at 700 rpm using a spin coater (trade name: MS-A150, Mikasa Inc.). Calcination of the glass substrate was performed on a hot stage at 140° C., and thus a transparent conductive film substrate I was prepared. Moreover, a transparent conductive film substrate II was prepared in a manner similar to the substrate I except that spin coating was performed at 3,000 rpm.

The transparent conductive film substrate I as obtained was evaluated to have a surface resistance value of 67.1Ω/□, a total luminous transmittance of 92.2% and a haze of 0.8%. Moreover, the transparent conductive film substrate II as obtained was evaluated to have a surface resistance value of 230Ω/□, a total luminous transmittance of 93.3% and a haze of 0.4%.

A solution containing the first component used in the invention was prepared as described below.

Preparation of a Solution Containing the First Component

Into a four-necked flask with an agitator, 3,3′,4,4′-diphenyl ether tetracarboxylic dianhydride (occasionally abbreviated as ODPA, hereafter), 1,4-butanediol (occasionally abbreviated as 14BD, hereafter), benzyl alcohol (occasionally abbreviated as BA, hereafter), 3,3′-diaminodiphenyl sulfone (occasionally abbreviated as DDS, hereafter), and methyl 3-methoxypropionate (occasionally abbreviated as 3MP, hereafter) as a polymerization solvent were loaded in the weights described below, and polymerization was performed by heating the resultant mixture at 130° C. for 3 hours under a nitrogen atmosphere.

| | |
|---|---|
| 3MP | 493.0 g |
| ODPA | 143.5 g |
| 14BD | 25.0 g |
| BA | 20.0 g |
| DDS | 23.0 g |

Then, the solution was cooled to room temperature, and a solution having 30 wt % of polyester amide acid (A) was obtained.

A part of the solution was sampled, and the weight average molecular weight of the polyester amide acid (A) was measured by a GPC analysis (polystyrene standard) to be 4,200.

### Example 1

### Preparation of a Thermosetting Composition

Then, 40.0 g of the solution having 30 wt % of polyester amide acid (A) as the first component, 23.7 g of VG-3101L (trade name, from Printec Co., Ltd.) as the second component, 2.36 g of trimellitic anhydride (occasionally abbreviated as TMA, hereafter) as the third component, 0.56 g of fluorine surfactant F-477 (trade name, from DIC, Inc.) as a surfactant, and 0.2 g of Irganox 1010 (trade name, from BASF Japan Ltd.) and 1.9 g of S-510 (trade name, from JNC Corporation) as additive components were weighed, 121.7 g of diethylene glycol ethylmethyl ether (occasionally abbreviated as EDM, hereafter) and 610.8 g of 3MP both as solvents were added thereto, and the resultant mixture was agitated until a homogeneous solution was formed. Thus, a thermosetting composition I having a composition as described below was obtained.

| | |
|---|---|
| Polyester amide acid (A) | 1.50 wt % |
| VG-3101L | 2.96 wt % |
| TMA | 0.29 wt % |
| Irganox 1010 | 0.02 wt % |
| S-510 | 0.24 wt % |
| F-477 | 0.07 wt % |
| EDM | 15.19 wt % |
| 3MP | 79.73 wt % |

Formation of a Protective Film

0.5 mL of the obtained thermosetting composition I was added dropwise on the transparent conductive film of the transparent conductive film substrate I, and spin coating was performed at 1,000 rpm using a spin coater (trade name: MS-A150, Mikasa, Inc). The glass substrate was dried on a hot plate at 80° C. for 180 seconds. Then, the substrate was calcinated on a hot stage at 230° C. for 30 minutes, and thus a transparent conductive film substrate I with a protective film was obtained.

Evaluation of Transparent Conductive Film Substrate with Protective Film

The obtained transparent conductive film substrate I with the protective film was evaluated to have a surface resistance value of 71.6Ω/□, a total luminous transmittance of 91.8%, a haze of 0.6%, and a protective film thickness of 120 nanometers. Moreover, the contactability were solghtly good (O), the hardness was excellent (OO) and environmental resistance was slightly good (O). The evaluation result is shown in Table 1.

### Example 2

### Formation of Protective Film

A transparent conductive film substrate II with a protective film was obtained with a composition and in a manner similar to Example 1 except that the calcination was performed on a hot plate at 150° C. for 15 minutes.

Evaluation of Transparent Conductive Film Substrate with Protective Film

The obtained transparent conductive film substrate II with the protective film was evaluated to have a surface resistance value of 67.2Ω/□, a total luminous transmittance of 91.1%, a haze of 0.6%, and a protective film thickness of 120 nm. Moreover, the contactability was slightly good (O), and the hardness and the environmental resistance were excellent (OO).

### Example 3

### Formation of Protective Film

A transparent conductive film substrate III with a protective film was obtained with a composition and in a manner similar to Example 2 except that the spin coating was performed at 4,000 rpm.

Evaluation of Transparent Conductive Film Substrate with Protective Film

The obtained transparent conductive film substrate III with the protective film was evaluated to have a surface resistance value of 67.5Ω/□, a total luminous transmittance of 91.1%, a haze of 0.6%, and a protective film thickness of 65 nm. Moreover, the electrical contactability, the hardness and the environmental resistance were excellent (OO).

### Example 4

### Formation of Protective Film

A transparent conductive film substrate IV with a protective film was obtained with a composition and in a manner similar to Example 1 except that calcination was performed on a hot plate at 100° C. for 15 minutes.

Evaluation of Transparent Conductive Film Substrate with Protective Film

The obtained transparent conductive film substrate IV with the protective film was evaluated to have a surface resistance value of 67.1Ω/□, a total luminous transmittance of 90.7%, a haze of 0.6%, and a protective film thickness of 120 nm. The electrical contactability was slightly good (O). The hardness and the environmental resistance were excellent (OO).

### Example 5

### Formation of Protective Film

A transparent conductive film substrate V with a protective film was obtained with a composition and in a manner similar to Example 4 except that the spin coating was done at 4,000 rpm.

Evaluation of Transparent Conductive Film Substrate with Protective Film

The obtained transparent conductive film substrate V with the protective film was evaluated to have a surface resistance value of 67.1Ω/□, a total luminous transmittance of 90.9%, a haze of 0.6%, and a protective film thickness of 65 nm. Moreover, the electrical contactability, the hardness and the environmental resistance were excellent (OO).

### Example 6

### Formation of a Protective Film

A transparent conductive film substrate VI with a protective film was obtained with a composition and in a manner similar to Example 3 except that the transparent conductive film substrate II was used.

Evaluation of Transparent Conductive Film Substrate with Protective Film

The obtained transparent conductive film substrate VI with the protective film was evaluated to have a surface resistance value of 223Ω/□, a total luminous transmittance of 91.5%, a haze of 0.3%, and a protective film thickness of 65 nm. Moreover, the electrical contactability, the hardness and the environmental resistance were excellent (OO).

### Example 7

### Preparation of Thermosetting Composition

A thermosetting composition II having the following composition was obtained with a composition and in a manner similar to Example 1 except that 0.56 g of silicone surfactant BYK-344 (trade name, from BASF Japan Ltd.) was used in place of F-477 as a surfactant.

| | |
|---|---|
| Polyester amide acid (A) | 1.50 wt % |
| VG-3101L | 2.96 wt % |
| TMA | 0.29 wt % |
| Irganox 1010 | 0.02 wt % |
| S-510 | 0.24 wt % |
| BYK-344 | 0.07 wt % |
| EDM | 15.19 wt % |
| 3MP | 79.73 wt % |

Formation of Protective Film

A transparent conductive film substrate VII with a protective film was obtained with a composition and in a manner similar to Example 3 except that thermosetting composition II was used.

Evaluation of Transparent Conductive Film Substrate with Protective Film

The obtained transparent conductive film substrate VII with the protective film was evaluated to have a surface resistance value of 70.5Ω/□, a total luminous transmittance of 90.9%, a haze of 0.7%, and a protective film thickness of 65 nm. Moreover, the electrical contactability and the hardness were excellent (OO), and the environmental resistance was slightly good (O).

### Example 8

### Preparation of Thermosetting Composition

A thermosetting composition III having the following composition was obtained with a composition and in a manner similar to Example 1 except that 0.56 g of fluorine surfactant TF-1366 (trade name, from DIC, Inc.) was used in place of F-477 as a surfactant.

| | |
|---|---|
| Polyester amide acid (A) | 1.50 wt % |
| VG-3101L | 2.96 wt % |
| TMA | 0.29 wt % |
| Irganox 1010 | 0.02 wt % |
| S-510 | 0.24 wt % |
| TF-1366 | 0.07 wt % |
| EDM | 15.19 wt % |
| 3MP | 79.73 wt % |

Formation of a Protective Film

A transparent conductive film substrate VIII with a protective film was obtained with a composition and in a manner similar to Example 3 except that the thermosetting composition III was used.

Evaluation of Transparent Conductive Film Substrate with Protective Film

The obtained transparent conductive film substrate VIII with the protective film was evaluated to have a surface resistance value of 67.2Ω/□, a total luminous transmittance of 91.1%, a haze of 0.6%, and a protective film thickness of 65 nm. Moreover, the electrical contactability, the hardness and the environmental resistance were excellent (OO).

### Comparative Example 1

The transparent conductive film substrates I and II were evaluated, without a protective film formed thereon, to have poor (XX) environmental resistance and hardness.

The substrates were not protected with the protective film in Comparative Example 1, and therefore their environmental resistance and hardness were confirmed to be poor (XX).

### Comparative Example 2

### Preparation of Thermosetting Composition

Based on the Examples described in JP 2008-156546 A, a thermosetting composition as described below was prepared.

Specifically, 100.0 g of a solution having 30 wt % of polyester amide acid (A), 60.0 g of VG-3101L, 6.0 g of TMA, 0.46 g of BYK-344, 0.5 g of Irganox 1010 and 4.8 g of S-510 were weighed, 64.2 g of EDM and 186.6 g of 3MP both as solvents were added thereto, and the resultant mixture was agitated until a homogeneous solution was formed. Thus, a thermosetting composition IV having the following composition was obtained.

| | |
|---|---|
| Polyester amide acid (A) | 7.100 wt % |
| VG-3101L | 14.199 wt % |
| TMA | 1.420 wt % |
| Irganox 1010 | 0.118 wt % |
| S-510 | 1.136 wt % |
| BYK-344 | 0.109 wt % |
| EDM | 15.193 wt % |
| 3MP | 60.725 wt % |

Formation of Protective Film

A transparent conductive film substrate IX with a protective film was obtained in a manner similar to Example 1 except that the thermosetting composition IV was used.

Evaluation of Transparent Conductive Film Substrate with Protective Film

The obtained transparent conductive film substrate IX with the protective film was evaluated to have a surface resistance value of 80.1Ω/□, a total luminous transmittance of 91.5%, a haze of 1.2%, and a protective film thickness of 1,100 nanometers. Moreover, the electrical contactability and the environmental resistance were poor (XX), and the hardness was excellent (OO).

In Comparative Example 2, the haze rose by calcination and degradation of conductivity and haze were caused under a high temperature and a high humidity. Moreover, the electrical contactability was poor (XX). The causes thereof are presumably attributed to the low applicability of thermosetting composition IV onto the transparent conductive film substrate, the large film thickness of the obtained protective film, generation of cracks on the protective film due to the difference in thermal shrinkage between the transparent conductive film and the protective film during the calcination, and so on.

### Comparative Example 3

### Formation of Protective Film

A transparent conductive film substrate X with a protective film was obtained with a composition and in a manner similar to Comparative Example 2 except that the calcination was performed at 150° C. for 15 minutes.

Evaluation of Transparent Conductive Film Substrate with Protective Film

The obtained transparent conductive film substrate X with the protective film was evaluated to have a surface resistance value of 67.5Ω/□, a total luminous transmittance of 91.3%, a haze of 1.1%, and a protective film thickness of 1,100 nm. The electrical contactability and the environmental resistance were poor (XX). The hardness was somewhat poor (X).

In Comparative Example 3, the haze rose by calcination and degradation of conductivity and haze were caused under a high temperature and a high humidity. Moreover, the electrical contactability was poor (XX), and the hardness was somewhat poor (X). The causes thereof are presumably attributed to similar causes in Comparative Example 2. In Comparative Example 3, the presence of remaining solvent in the protective film after the calcination presumably causes lowering of the hardening properties or deterioration of the optical characteristics of the protective film under a high temperature and a high humidity.

### Comparative Example 4

Based on Example 2 described in JP 2009-505358 A, a transparent conductive film substrate with a protective film was prepared according to the following procedure.

Super Fast-Drying Polyurethane Satin (trade name, from Minwax Company) was diluted by 8 times with methyl ethyl ketone. On the transparent conductive film of the transparent conductive film substrate I, 0.5 mL of the solution was added dropwise, and spin coating was performed at 1,500 rpm using a spin coater (trade name: MS-A150, Mikasa, Inc.). The substrate was dried at room temperature for 4 hours, and thus transparent conductive film substrate XI with a protective film was obtained.

Evaluation of Transparent Conductive Film Substrate with Protective Film

The obtained transparent conductive film substrate XI with the protective film was evaluated to have a surface resistance value of 67.5Ω/□, a total luminous transmittance of 91.1%, a haze of 0.9%, and a protective film thickness of 100 nm. Moreover, the electrical contactability and the hardness were excellent (OO), and the environmental resistance was poor (XX).

In Comparative Example 4, deterioration of conductivity under a high temperature and a high humidity was caused. The causes thereof are presumably attributed to the insufficient shielding properties of the protective film, and so on, because the used composition used had a constitution different from the thermosetting composition of the invention,

### Comparative Example 5

### Preparation of Thermosetting Composition

Based on the Examples described in JP 2011-204649 A, a thermosetting composition as described below was prepared.

Specifically, 208 g of tetraethoxysilane was diluted with 356 g of methanol and 18 g of water, 18 g of 0.01 N hydrochloric acid aqueous solution was added, and the resultant mixture was agitated for 2 hours under room temperature and then diluted with methanol to be 5 wt % in the total solid content. Thus, a thermosetting composition X was obtained.

Formation of Protective Film

0.5 mL of the obtained thermosetting composition X was added dropwise on the transparent conductive film of the transparent conductive film substrate I, and spin coating was performed at 1,500 rpm using a spin coater (trade name: MS-A150, Mikasa, Inc). The glass substrate was calcinated on a hot plate at 120° C. for 5 minutes, and thus a transparent conductive film substrate XII with a protective film was obtained.

Evaluation of Transparent Conductive Film Substrate with Protective Film

The obtained transparent conductive film substrate XII with the protective film was evaluated to have a surface resistance value of 79.5Ω/□, a total luminous transmittance of 91.0%, a haze of 0.9%, and a protective film thickness of 100 nm. Moreover, the electrical contactability and the hardness were excellent (OO), and the environmental resistance was poor (XX).

In Comparative Example 5, degradation of conductivity was caused under a high temperature and a high humidity. The causes thereof are presumably attributed to elution of an acid catalyst used in the thermosetting composition X from the protective film under the high temperature and the high humidity, corrosion of silver nanowires due to a high gas permeability of the hardened film, and so on. In addition, a similar film can be formed at a calcination temperature of approximately 300° C. without using the acid catalyst. However, such case is not suitable because the silver nanowires are damaged by the high temperature.

TABLE 1

| | Conduc- | Transparency | | | | |
|---|---|---|---|---|---|---|
| | tivity | Total | | | | |
| | Surface | luminous | | | | Environ- |
| | resis- | transmit- | | | | mental |
| | tance | tance | Haze | Contact- | Hard- | resis- |
| | (Ω/□) | (%) | (%) | ability | ness | tance |
| Transparent | 67.1 | 92.2 | 0.8 | — | — | — |
| conductive | | | | | | |
| film | | | | | | |
| substrate I | | | | | | |
| Transparent | 230 | 93.3 | 0.4 | — | — | — |
| conductive | | | | | | |
| film | | | | | | |
| substrate II | | | | | | |
| Example 1 | 71.6 | 91.8 | 0.6 | O | OO | O |
| Example 2 | 67.2 | 91.1 | 0.6 | O | OO | OO |
| Example 3 | 67.5 | 91.1 | 0.6 | OO | OO | OO |
| Example 4 | 67.1 | 90.7 | 0.6 | O | OO | OO |
| Example 5 | 67.1 | 90.9 | 0.6 | OO | OO | OO |
| Example 6 | 223 | 91.5 | 0.3 | OO | OO | OO |
| Example 7 | 70.5 | 90.9 | 0.7 | OO | OO | O |
| Example 8 | 67.2 | 91.1 | 0.6 | OO | OO | OO |
| Comparative | — | — | — | OO | XX | XX |
| Example 1 | | | | | | |
| Comparative | 80.1 | 91.5 | 1.2 | XX | OO | XX |
| Example 2 | | | | | | |
| Comparative | 67.5 | 91.3 | 1.1 | XX | X | XX |
| Example 3 | | | | | | |
| Comparative | 67.5 | 91.1 | 0.9 | OO | OO | XX |
| Example 4 | | | | | | |
| Comparable | 79.5 | 91.0 | 0.9 | OO | OO | XX |
| Example 5 | | | | | | |

### INDUSTRIAL APPLICABILITY

A protective film for a transparent conductive film according to the invention can be used in a process for manufacturing device elements such as a liquid crystal display device, an organic electroluminescence display, an electronic paper, a touch panel device and a photovoltaic device.

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

What is claimed is:

1. A thermosetting composition for forming a protective film of a transparent conductive film including a nanostructure, containing:
polyester amide acid obtained from a reaction of a mixture containing tetracarboxylic dianhydride, diamine and a polyhydric hydroxy compound as a first component;
an epoxy resin as a second component;
an epoxy curing agent as a third component; and
a solvent as a fourth component,
wherein the first component is in a range of 0.5 to 2.5% by weight, the second component is in a range of 0.4 to 5% by weight, the third component is in a range of 0.1 to 0.7% by weight, and the fourth component is in a range of 91.8 to 99% by weight, based on the total amount of the composition.

2. The thermosetting composition according to claim 1, wherein the first component is a compound obtained from a reaction of a mixture containing 3,3′,4,4′-diphenyl ether tetracarboxylic di anhydride, 3,3′-diaminodiphenyl sulfone and 1,4-butanediol, and has a weight average molecular weight in a range of 1,000 to 50,000.

3. The thermosetting composition according to claim 2, further containing benzyl alcohol in the mixture of the first component.

4. The thermosetting composition according to claim 1, wherein the second component is an epoxy resin represented by formula (A) as shown below:

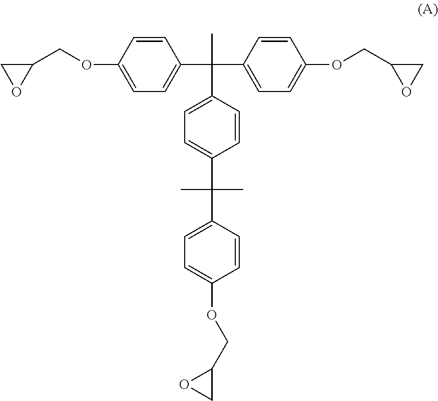 [SMILES: CC(C)(c1ccc(OCC2CO2)cc1)c1ccc(C(C)(c2ccc(OCC3CO3)cc2)c2ccc(OCC3CO3)cc2)cc1]

5. The thermosetting composition according to claim 1, wherein the third component is trimellitic anhydride.

6. The thermosetting composition according to claim 1, further containing a fluorine surfactant as a fifth component.

7. The thermosetting composition according to claim 6, wherein the fifth component is in a range of 3 to 6 parts by weight based on 100 parts by weight of the first component.

8. The thermosetting composition according to claim 1, wherein the nanostructure is metal nanowires.

9. The thermosetting composition according to claim 8, wherein the nanostructure is silver nanowires.

10. A method for forming a protective film of a transparent conductive film including a nanostructure, comprising:
a process 1 for applying the thermosetting composition according to claim 1 onto the transparent conductive film including the nanostructure; and
a process 2 for heating the thermosetting composition at a temperature in a range of 80° C. to 160° C.

11. The method for forming the protective film according to claim 10, wherein a temperature of the heating is in a range of 80° C. to 100° C. in the process 2 according to claim 10.

12. A protective film obtained by applying the method for forming the protective film according to claim 10, wherein a film thickness of the protective film is in a range of 40 nm to 150 nm.

13. A laminate comprising the protective film according to claim 12, a transparent conductive film including a nanostructure, and a substrate, wherein surface resistance of the transparent conductive film is in a range of 10Ω/□ to 500Ω/□, a total luminous transmittance of the laminate is 85% or more, and a haze of the laminate is 3% or less.

14. An electronic device using the laminate according to claim 13.
